(19) United States
(12) Patent Application Publication
(10) Pub. No.: US 2019/0277210 A1
(43) Pub. Date: Sep. 12, 2019

(54) CONTROL DEVICE FOR INTERNAL COMBUSTION ENGINE

(71) Applicant: HONDA MOTOR CO., LTD., Tokyo (JP)

(72) Inventors: Shusuke Akazaki, Wako-shi (JP); Taisuke Inoue, Wako-shi (JP)

(21) Appl. No.: 16/288,295

(22) Filed: Feb. 28, 2019

(30) Foreign Application Priority Data
Mar. 9, 2018 (JP) 2018-043079

(51) Int. Cl. F02D 35/02; F02B 77/08

(52) U.S. Cl. CPC F02D 35/024; F02B 77/086; F02D 35/025

(57) ABSTRACT

A control device for an internal combustion engine can correct precisely a detection result of an in-cylinder pressure sensor which may generate a detection error in a temperature changing process, to control the operation with a smaller error. The control device includes: an operational parameter calculating section that calculates an operational parameter related to control of the engine based on the sensor signal from the sensor; a sensor temperature estimating section that estimates a current temperature change amount of the sensor based on an operating state of the engine; a storage section which stores a correction amount map indicating a correction amount for an operational parameter in accordance with a temperature change amount of the sensor; and an operational parameter output section that corrects the calculated operational parameter with reference to the correction amount map based on the estimated temperature change amount of the sensor, to output the corrected operational parameter.

### INCORPORATION BY REFERENCE

The present application claims priority under 35 U.S.C.§ 119 to Japanese Patent Application No. 2018-043079 filed on Mar. 9, 2018. The content of the application is incorporated herein by reference in its entirety.

### BACKGROUND OF THE INVENTION

### Field of the Invention

The present invention relates to a control device for an internal combustion engine which controls operation of the internal combustion engine based on a signal from an in-cylinder pressure sensor for detecting an in-cylinder pressure of the internal combustion engine.

### Description of the Related Art

There has been conventionally known a ring-shaped in-cylinder pressure sensor as an in-cylinder pressure sensor for detecting an in-cylinder pressure of the internal combustion engine, which comprises a pressure detection element to be mounted to surround the periphery of a fuel injection hole of a fuel injection valve for direct injection (International Publication No. WO2012/115036). This ring-shaped in-cylinder pressure sensor includes a ring-shaped diaphragm which is provided at distal end portions of an inner cylinder and an outer cylinder which are coaxially provided around a fuel injection hole and are made of metal, to thereby close a clearance space formed between these cylinders, for example. The in-cylinder pressure is detected by detecting a load which generates deformation of this diaphragm, using a pressure detection element.

The diaphragm portion of the above-described ring-shaped in-cylinder pressure sensor is inserted into the fuel injection hole of the fuel injection valve and a cylinder head, and therefore the ring-shaped in-cylinder pressure sensor can be cooled together with the fuel injection valve by cooling water for cooling the cylinders and detect the in-cylinder pressure with good precision.

However, the above-described ring-shaped in-cylinder pressure sensor can detect the in-cylinder pressure with good precision if a housing temperature of the sensor converges at a constant temperature, but a slight error may be caused in the detection result of the in-cylinder pressure while the housing temperature is changing. That is, a temperature difference is generated between the inner cylinder and the outer cylinder described above while the housing temperature is changing, which causes a difference in the state of the thermal expansion and retraction between the inner cylinder and the outer cylinder, resulting in volume change in the above-described clearance space. Therefore, the volume change in the clearance space causes additional deformation on the above-described diaphragm, and the additional deformation causes additional stress on the above-described pressure detection element, which may cause an error in the detection result of the in-cylinder pressure.

The correction of such a detection error while the housing temperature of the in-cylinder pressure sensor is changing needs to be performed in accordance with the mode of the temperature change, and in the conventional correction based on a uniform relationship between a temperature value and a correction amount, it is difficult to perform appropriate correction.

In view of the above background, in a control device which controls operation of an internal combustion engine, it is required to correct precisely a detection result of an in-cylinder pressure sensor which may generate a detection error in a temperature changing process, in order to control the operation with a smaller error.

### SUMMARY OF THE INVENTION

One aspect of the present invention provides a control device for an internal combustion engine which controls operation of the internal combustion engine based on a sensor signal from an in-cylinder pressure sensor, the control device including: an operational parameter calculating section that calculates an operational parameter related to control of the internal combustion engine based on the sensor signal from the in-cylinder pressure sensor; a sensor temperature estimating section that estimates a current temperature change amount of a sensor temperature which is a temperature of the in-cylinder pressure sensor based on an operating state of the internal combustion engine; a storage section which stores a correction amount map indicating a correction amount for the operational parameter in accordance with a temperature change amount of the in-cylinder pressure sensor; and an operational parameter output section that corrects the operational parameter calculated by the operational parameter calculating section with reference to the correction amount map based on a temperature change amount of the in-cylinder pressure sensor estimated by the sensor temperature estimating section, to output the corrected operational parameter.

According to another aspect of the present invention, the storage section further stores a steady-state sensor temperature map that indicates a steady-state sensor temperature which is the sensor temperature in a steady state under various operating conditions of the internal combustion engine, and a sensor temperature change curve map that includes a predetermined reference change curve showing a change of the sensor temperature with respect to the number of combustion strokes of the internal combustion engine from a time when the internal combustion engine is started or an operating condition of the internal combustion engine is changed to a time when the internal combustion engine reaches the steady state, and the sensor temperature estimating section obtains a cooling water temperature when the internal combustion engine is started or when the operating condition of the internal combustion engine is changed as a current sensor temperature when the internal combustion engine is started or when the operating condition of the internal combustion engine is changed, refers to the steady-state sensor temperature map based on the operating condition after the internal combustion engine is started or after the operating condition is changed, to obtain an estimated value of the steady-state sensor temperature under the corresponding operating condition, and estimates a current change amount of the sensor temperature based on the sensor temperature, the estimated value of the steady-state sensor temperature, the reference change curve, and the number of combustion strokes from the time when the internal combustion engine is started or the operating condition is changed to a present time, which are obtained above.

According still another aspect of the present invention, the operational parameter output section corrects the calculated operational parameter in a period during which a temperature change amount of the in-cylinder pressure sensor estimated by the sensor temperature estimating section is greater than or equal to a predetermined threshold.

According to yet another aspect of the present invention, the operational parameter includes at least one of an indicated mean effective pressure, an estimated output torque, and a mass fraction burn curve.

According to further aspect of the present invention, the operating condition is an operating condition which affects a combustion temperature in a cylinder.

According to still further aspect of the present invention, the operating condition includes at least one of an air-fuel ratio, a compression ratio, an intake air amount, ignition timing, an EGR amount, air intake and exhaust timing, and a supercharging pressure.

According to the present invention, a control device which controls operation of an internal combustion engine can correct precisely a detection result of an in-cylinder pressure sensor which may generate a detection error in a temperature changing process, to control the operation with a smaller error.

### BRIEF DESCRIPTION OF THE DRAWINGS

FIG. 1 is a diagram illustrating a configuration of an electronic control unit which is a control device for an internal combustion engine according to one embodiment of the present invention;

FIG. 2 is a graph showing one example of operation of a sensor temperature estimating section in the electronic control unit illustrated in FIG. 1;

FIG. 3 is a graph showing another example of operation of the sensor temperature estimating section in the electronic control unit illustrated in FIG. 1;

FIG. 4 is a graph showing one example of a correction amount map in the electronic control unit illustrated in FIG. 1;

FIG. 5 is a graph showing an example of change curves of an estimated motoring pressure calculated in the electronic control unit illustrated in FIG. 1 and an in-cylinder pressure detected by an in-cylinder pressure sensor; and

FIG. 6 is a flowchart illustrating derivation processing of an operational parameter in the electronic control unit illustrated in FIG. 1.

### DETAILED DESCRIPTION OF THE PREFERRED EMBODIMENTS

Hereinafter, embodiments of the present invention will be described with reference to the drawings.

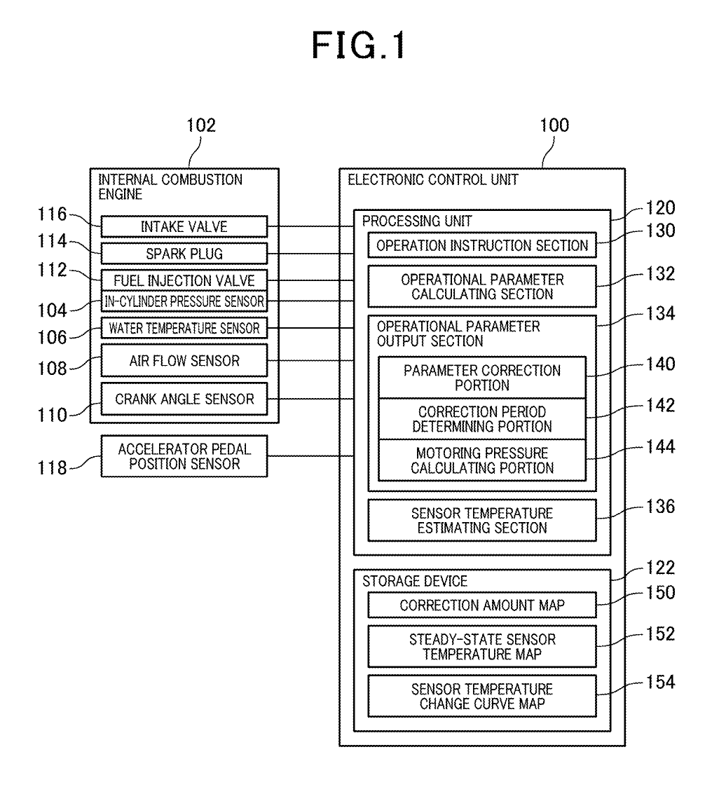

FIG. 1 is a diagram illustrating a configuration of an electronic control unit (ECU) 100 which is a control device for controlling operation of an internal combustion engine according to one embodiment of the present invention. The electronic control unit 100 is mounted in a vehicle (not illustrated) using an internal combustion engine 102, and controls operation of the internal combustion engine 102 by controlling a fuel injection valve 112, a spark plug 114, an intake valve 116, and the like based on sensor signals from an in-cylinder pressure sensor 104, a water temperature sensor 106, an air flow sensor 108, and a crank angle sensor 110 which are provided in the internal combustion engine 102, and an accelerator pedal position sensor 118 and the like.

The in-cylinder pressure sensor 104 detects an in-cylinder pressure, and outputs a sensor signal which is a detection signal of the in-cylinder pressure. The in-cylinder pressure sensor 104 has a characteristic in that an error included in the detection signal of the in-cylinder pressure is increased in a state in which the temperature of a housing (a sensor housing) of the in-cylinder pressure sensor 104 is changing until it reaches the steady state. In the present embodiment, the in-cylinder pressure sensor 104 is, for example, a ring-shaped in-cylinder pressure sensor having a configuration similar to the configuration disclosed in International Publication No. WO2012/115036, and is attached together with the fuel injection valve 112 to the cylinder so that a diaphragm provided at a distal end of the in-cylinder pressure sensor 104 is exposed to the interior of a combustion chamber (not illustrated) of the internal combustion engine 102.

Here, in the following description, the temperature of the in-cylinder pressure sensor 104 (more precisely, the temperature of the sensor housing of the in-cylinder pressure sensor 104) is referred to as a “sensor temperature.”

The water temperature sensor 106, the air flow sensor 108 and the crank angle sensor 110 detect the temperature of the cooling water of the cylinder head (a cooling water temperature), an air intake amount (an intake air amount), and a rotation angle of an output shaft of the internal combustion engine 102, respectively. The accelerator pedal position sensor 118 detects, for example, an amount by which an accelerator pedal operated by a driver is depressed.

The electronic control unit 100 includes a processing unit 120 and a storage device 122 which is a storage section. The storage device 122 includes, for example, a non-volatile semiconductor memory or a hard disk device, and may include a volatile semiconductor memory. The storage device 122 stores a correction amount map 150, a steady-state sensor temperature map 152, and a sensor temperature change curve map 154 therein.

The correction amount map 150 is a map indicating a correction amount for an operational parameter related to operation of the internal combustion engine 102 in accordance with a temperature change amount of the sensor temperature which is a temperature of the sensor housing of the in-cylinder pressure sensor 104. Here, the change amount of the sensor temperature means an amount directly or indirectly indicating the rate of change of the sensor temperature such as a temperature change amount per unit time of the sensor, for example. In the present embodiment, the change amount of the sensor temperature is a change amount per one combustion stroke of the internal combustion engine 102, for example.

The steady-state sensor temperature map 152 indicates a steady-state sensor temperature which is a sensor temperature in a steady state under various operating conditions of the internal combustion engine 102. Here, the “sensor temperature in a steady state” means a sensor temperature when the sensor temperature reaches a stable state after the internal combustion engine 102 operates under various operating conditions. Here, the “stable state” means a state in which a temporal change amount of the sensor temperature converges to within less than or equal to a predetermined value. Note that in a warm-up period immediately after the internal combustion engine 102 is started, whether the internal combustion engine 102 has reached the steady state can be evaluated by a temperature of the cooling water to be warmed by the internal combustion engine 102. For example, the sensor temperature when the cooling water temperature has become 80° C. or higher by the warm-up operation of the internal combustion engine 102 can be defined as a steady-state sensor temperature indicating that the sensor temperature has reached the above-described steady state.

Here, the operating conditions in the present embodiment mean operating conditions which may affect the combustion temperature in the cylinder, and include at least one of an air-fuel ratio, a compression ratio, an intake air amount, ignition timing, an EGR amount, air intake and exhaust timing, an engine speed, and a supercharging pressure. The steady-state sensor temperature map 152 indicates a steady-state sensor temperature according to various operating conditions which may affect the combustion temperature in the cylinder.

More specifically, the steady-state sensor temperature map 152 includes “a steady-state sensor temperature after start-up” which is obtained after warming up the internal combustion engine 102 when the internal combustion engine 102 is started under various operating conditions, for example. The steady-state sensor temperature after start-up includes “a steady-state sensor temperature after start-up with a retardation” in which the above-described operating conditions include an ignition timing retardation for increasing the temperature of catalyst in the exhaust path after the internal combustion engine 102 is started, and the steady-state sensor temperature after start-up further includes “a steady-state sensor temperature after start-up without a retardation” in which the above-described operating conditions do not include the ignition timing retardation.

The steady-state sensor temperature included in the steady-state sensor temperature map 152 includes “a combustion-mode specific steady-state sensor temperature” which is a steady-state sensor temperature under each of various operating conditions according to respective various combustion modes such as a stoichiometric combustion mode in which fuel in the cylinder is burned at or near a theoretical air-fuel ratio, and an ultra-lean combustion mode in which fuel is burned under the ultra-lean conditions close to diesel combustion, for example.

The sensor temperature change curve map 154 includes a predetermined reference change curve showing a change of the sensor temperature with respect to the number of combustion strokes of the internal combustion engine 102 from the time when the internal combustion engine 102 is started or the operating condition of the internal combustion engine 102 is changed to the time when the internal combustion engine 102 reaches the steady state (that is, the sensor temperature reaches the stable state). This reference change curve includes “a reference change curve at start-up” showing a change of the sensor temperature until the internal combustion engine 102 is warmed up at starting-up of the internal combustion engine 102 and the sensor temperature reaches the steady-state sensor temperature, for example. The reference change curve includes “a reference change curve at combustion-mode change” showing a change of the sensor temperature when one combustion mode (for example, the above-described stoichiometric combustion mode) is shifted to the other combustion mode (for example, the above-described ultra-lean combustion mode). The reference change curve at combustion-mode change may include a reference change curve at combustion-mode change in the case in which the combustion temperature in the other combustion mode described above is higher than the combustion temperature in the one combustion mode described above and the sensor temperature is increased, and may include a reference change curve at combustion-mode change in the case in which the combustion temperature in the other combustion mode described above is lower than the combustion temperature in the one combustion mode described above and the sensor temperature is decreased.

The processing unit 120 is a computer provided with a processor such as a CPU (Central Processing Unit), for example. The processing unit 120 may include a ROM (Read Only Memory) in which a program is written, a RAM (Random Access Memory) for temporarily storing data, and the like. The processing unit 120 includes an operation instruction section 130, an operational parameter calculating section 132, an operational parameter output section 134, and a sensor temperature estimating section 136 as functional elements (or functional units). The operational parameter output section 134 includes a parameter correction portion 140, a correction period determining portion 142, and a motoring pressure calculating portion 144.

These functional elements included in the processing unit 120 are implemented by executing a program by the processing unit 120 which is a computer, for example. Note that the above-described computer program may be stored in arbitrary computer readable storage medium. Instead to this, all or some of the above-described functional elements included in the processing unit 120 can each be configured of hardware including one or more electronic circuit components.

The operation instruction section 130 controls operation of the internal combustion engine 102 by driving the intake valve 116, the spark plug 114, the fuel injection valve 112 and the like based on a target torque and/or a target speed which is obtained from the accelerator pedal position sensor 118, an operational parameter output from the operational parameter output section 134, and the like.

The operational parameter calculating section 132 calculates the operational parameter related to control of the internal combustion engine 102 based on a sensor signal from the in-cylinder pressure sensor 104. Here the above-described operational parameter in the present embodiment is an IMEP (Indicated Mean Effective Pressure).

The operational parameter output section 134 corrects the operational parameter calculated by the operational parameter calculating section 132 as needed, and outputs the above-described calculated operational parameter or the corrected operational parameter to the operation instruction section 130.

The sensor temperature estimating section 136 estimates a current temperature change amount (the change amount of the sensor temperature) of the in-cylinder pressure sensor 104 based on the operating state of the internal combustion engine 102. Specifically, the water temperature sensor 106 measures the cooling water temperature when the internal combustion engine 102 is started or the operating condition of the internal combustion engine 102 is changed, and the sensor temperature estimating section 136 obtains the measured cooling water temperature as a current sensor temperature. Here, the reason that the cooling water temperature is obtained as a sensor temperature is because it can be considered that the sensor temperature obtained immediately before the internal combustion engine 102 is started is in the steady state, and therefore the cooling water temperature is approximately equal to the sensor temperature. Alternatively, this is because it can be considered that as long as the operating condition of the internal combustion engine 102 is not changed frequently, the sensor temperature obtained immediately before the operating condition of the internal combustion engine 102 is changed is in the steady state, and therefore the cooling water temperature is approximately equal to the sensor temperature.

The sensor temperature estimating section 136 obtains the sensor temperature as described above, and at the same time, starts counting the number of combustion strokes. Furthermore, the sensor temperature estimating section 136 refers to the steady-state sensor temperature map 152 based on the operating condition after the internal combustion engine 102 is started (the operating condition after start-up) or the operating condition after the operating condition is changed (the operating condition after change), to obtain an estimated value of the steady-state sensor temperature under the corresponding operating condition.

Note that if the steady-state sensor temperature map 152 includes no steady-state sensor temperature under the operating condition corresponding to the operating condition after start-up or the operating condition after change, the sensor temperature estimating section 136 can interpolate or extrapolate the steady-state sensor temperature under a plurality of operating conditions close to the operating condition after start-up or the operating condition after change to calculate the estimated value of the steady-state sensor temperature under the operating condition after start-up or the operating condition after change.

Furthermore, the sensor temperature estimating section 136 refers to the sensor temperature change curve map 154 to obtain the reference change curve of the sensor temperature when the internal combustion engine 102 is started or when the operating condition of the internal combustion engine 102 is changed. Then, the sensor temperature estimating section 136 estimates a current change amount of the sensor temperature based on the sensor temperature obtained above, the estimated value of the steady-state sensor temperature, the reference change curve, and the number of combustion strokes from the time when the internal combustion engine 102 is started or the operating condition of the internal combustion engine 102 is changed to the present time.

Specifically, the sensor temperature estimating section 136 modifies the reference change curve obtained above such that the modified reference change curve connects the estimated value of the steady-state sensor temperature to the sensor temperature at start of the internal combustion engine 102 or the sensor temperature at change of the operating condition of the internal combustion engine 102 which are obtained above, to calculate an estimated sensor temperature change curve. The sensor temperature estimating section 136 estimates a current change amount of the sensor temperature based on the calculated estimated sensor temperature change curve and the current number of combustion strokes.

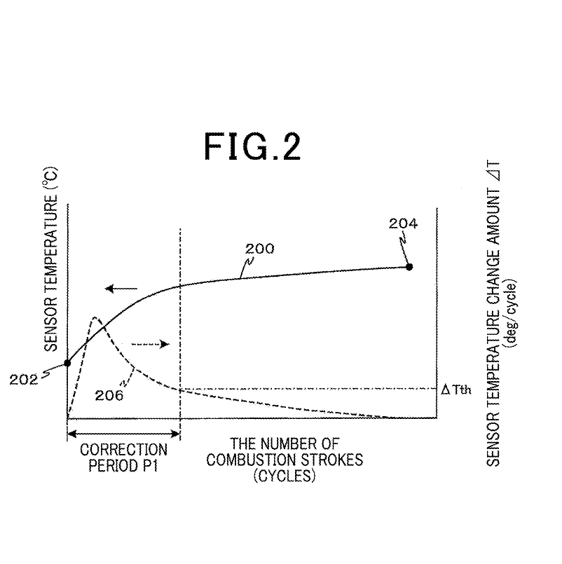

FIG. 2 is a graph showing one example of operation of the sensor temperature estimating section 136. FIG. 2 shows an estimated sensor temperature change curve 200 calculated by the sensor temperature estimating section 136 when the internal combustion engine 102 is started. In FIG. 2, the horizontal axis indicates the number of combustion strokes after the internal combustion engine 102 is started, and the vertical axis on the left side of the graph indicates the sensor temperature.

The estimated sensor temperature change curve 200 is calculated by the sensor temperature estimating section 136 modifying the reference change curve at start-up included in the sensor temperature change curve map 154 stored in the storage device 122 such that the modified reference change curve at start-up connects a sensor temperature 202 obtained at start of the internal combustion engine 102 to an estimated value 204 of the steady-state sensor temperature under the operating condition after the internal combustion engine 102 is started.

The sensor temperature estimating section 136 estimate the current change amount of the sensor temperature based on the number of combustion strokes from the time of starting the internal combustion engine 102 to the present time, by calculating variation of the estimated sensor temperature change curve 200 at the above number of combustion strokes. FIG. 2 shows a estimated sensor temperature change amount curve 206 as a dotted line which is a change curve of the sensor temperature change amount derived from the estimated sensor temperature change curve 200. The vertical axis on the right side of the graph indicates the sensor temperature change amount per one combustion stroke.

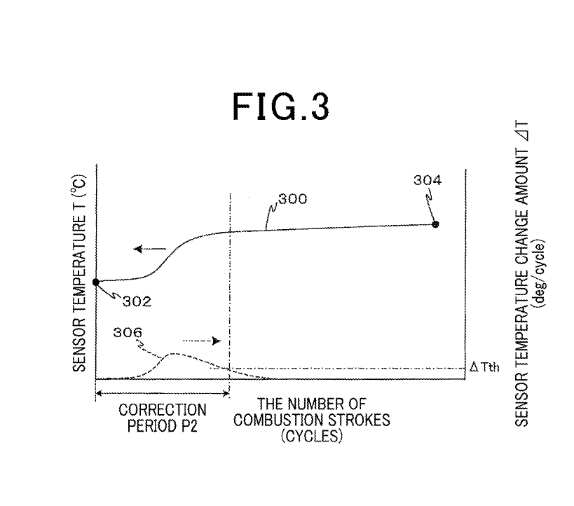

FIG. 3 is a graph showing another example of operation of the sensor temperature estimating section 136. FIG. 3 shows an estimated sensor temperature change curve 300 calculated by the sensor temperature estimating section 136 in a case where the operating condition of the internal combustion engine 102 is changed from the operating condition in an ultra-lean combustion mode to the operating condition in a stoichiometric combustion mode, for example. In FIG. 3, the horizontal axis indicates the number of combustion strokes after the operating condition is changed, and the vertical axis on the left side of the graph indicates the sensor temperature.

The estimated sensor temperature change curve 300 is calculated by the sensor temperature estimating section 136 modifying the reference change curve at combustion-mode change included in the sensor temperature change curve map 154 stored in the storage device 122 such that the modified reference change curve at combustion-mode change connects a sensor temperature 302 obtained at the time of changing the operating condition to an estimated value 304 of the steady-state sensor temperature under the operating condition after the changing of the operating condition.

The sensor temperature estimating section 136 estimate the current change amount of the sensor temperature based on the number of combustion strokes from the time of changing the operating condition of the internal combustion engine 102 to the present time, by calculating variation of the estimated sensor temperature change curve 300 at the above number of combustion strokes. FIG. 3 shows an estimated sensor temperature change amount curve 306 as a dotted line which is a change curve of the sensor temperature change amount derived from the estimated sensor temperature change curve 300. The vertical axis on the right side of the graph indicates the sensor temperature change amount per one combustion stroke.

Note that in the above description, the estimated sensor temperature change curves 200 and 300 can be calculated, for example, by scaling and/or shifting in the vertical axis direction (the sensor temperature axis direction) the reference change curve at start-up and the reference change curve at combustion-mode change, respectively, but the present embodiment is not limited thereto. For examples, the sensor temperature change curve map 154 stores the reference change curve expressed by a polynomial, and the sensor temperature estimating section 136 may calculate the estimated sensor temperature change curves 200, 300 by changing coefficients of the polynomial. In this case, the sensor temperature estimating section 136 repeatedly obtains the sensor temperature from the water temperature sensor 106 at an interval of a predetermined number of combustion strokes, and may correct the estimated sensor temperature change curves 200 and 300 by correcting the coefficients of the above-described polynomial every time the sensor temperature is obtained, so that the deviation of the obtained sensor temperature from the estimated value of the steady-state sensor temperature becomes the smallest, for example.

Returning to FIG. 1, when the present time is in a correction period, the parameter correction portion 140 refers to the correction amount map 150 and corrects the operational parameter calculated by the operational parameter calculating section 132 on the basis of the temperature change amount of the in-cylinder pressure sensor 104 estimated by the sensor temperature estimating section 136. Note that the correction period determining portion 142 (described later) determines whether the present time is in the correction period.

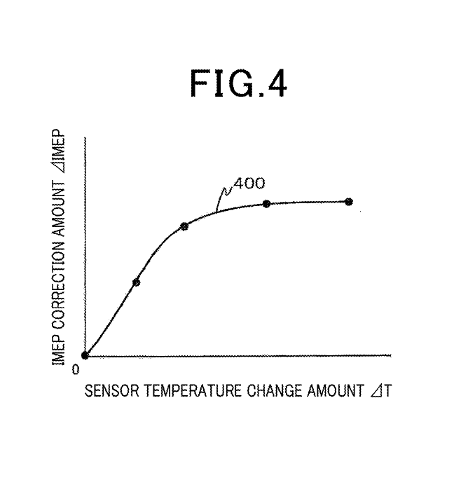

FIG. 4 is a graph showing an example of the correction amount map 150. In FIG. 4, the horizontal axis indicates a sensor temperature change amount ΔT which is a temperature change amount of the in-cylinder pressure sensor 104, and the vertical axis indicates a correction amount ΔIMEP of the IMEP which is an operational parameter in the present embodiment. A curve 400 indicates correction amounts ΔIMEP for the operational parameter IMEP at various temperature change amounts of the sensor temperature, wherein the operational parameter IMEP is calculated by the operational parameter calculating section 132.

Note that when the present time is not in the correction period, the operational parameter output section 134 outputs the operational parameter calculated by the operational parameter calculating section 132 as it is to the operation instruction section 130.

The operation instruction section 130 which has received the operational parameter from the operational parameter output section 134 calculates a torque value that is currently output by the internal combustion engine 102, for example, using the IMEP which is the received operational parameter. The operation instruction section 130 controls a lifting amount of the intake valve 116 of the internal combustion engine 102 so that the calculated torque value becomes equal to a target torque determined from a sensor signal of the accelerator pedal position sensor 118.

Note that, in the present embodiment, the IMEP is used as an operational parameter, but the present invention is not limited thereto. Such an operational parameter can be an arbitrary operational parameter that can be calculated based on the in-cylinder pressure obtained from the in-cylinder pressure sensor 104. For example, the operational parameter may include at least one of an IMEP (Indicated Mean Effective Pressure), an estimated output torque, and a mass fraction burn curve.

Returning to FIG. 1, the correction period determining portion 142 determines whether a correction period has started. Here, the correction period is a period in which the in-cylinder pressure sensor 104 is in a temperature change state and thus the operational parameter is required to be corrected based on the estimated sensor temperature change curve calculated by the sensor temperature estimating section 136. Specifically, the correction period determining portion 142 calculates the period of the number of combustion strokes during which the absolute value of the sensor temperature change amount is greater than or equal to a predetermined threshold, based on the estimated sensor temperature change curve calculated by the sensor temperature estimating section 136. When the current number of combustion strokes is in the above-described calculated period, the correction period determining portion 142 determines that the in-cylinder pressure sensor 104 is currently in the temperature change state and the present time is in the correction period requiring the correction of the operational parameter. For example, in the examples shown in FIG. 2 and FIG. 3, the correction period determining portion 142 regards the periods during which the estimated sensor temperature change amount curves 206, 306 calculated from the estimated sensor temperature change curves 200, 300 are greater than or equal to the predetermined threshold ΔTth as correction periods P1, P2, respectively.

Thus, in the correction period during which the temperature change amount of the in-cylinder pressure sensor 104 estimated by the sensor temperature estimating section 136 is greater than or equal to the predetermined threshold ΔTth, the operational parameter output section 134 corrects, with the parameter correction portion 140, the operational parameter calculated by the operational parameter calculating section 132 and outputs the corrected operational parameter to the operation instruction section 130.

The correction period determining portion 142 compares an estimated motoring pressure calculated by the motoring pressure calculating portion 144 (described later) with an in-cylinder pressure based on the sensor signal of the in-cylinder pressure sensor 104. And, if there is a crank angle period during which the in-cylinder pressure is below the estimated motoring pressure, the correction period determining portion 142 determines that the present time is in the correction period requiring the correction of the operational parameter. Here, the estimated motoring pressure represents the in-cylinder pressure when the combustion does not occur. Therefore, it is considered that the fact that the actual in-cylinder pressure obtained by the in-cylinder pressure sensor 104 when the combustion occurs is below the estimated motoring pressure means that non-negligible error is included in the sensor signal of the in-cylinder pressure sensor 104.

Thus, in the operational parameter output section 134, also in a case where there is a crank angle period during which the actual measured value of the in-cylinder pressure obtained from the in-cylinder pressure sensor 104 is below the estimated motoring pressure, the parameter correction portion 140 may correct the operational parameter calculated by the operational parameter calculating section 132 to output the corrected operational parameter to the operation instruction section 130. As a result, the electronic control unit 100 can control the operation of the internal combustion engine 102 more appropriately.

Note that when the correction period determining portion 142 determines that the present time is in the correction period because there exist the crank angle period during which the actual measured value of the in-cylinder pressure is below the estimated motoring pressure, the parameter correction portion 140 replaces the actual measured value of the in-cylinder pressure in the above-described crank angle period with the estimated motoring pressure, thereby enabling the corrected operational parameter to be calculated using the above-described actual measured value of the in-cylinder pressure and the estimated motoring pressure. The corrected operational parameter is then output to the operation instruction section 130 by the operational parameter output section 134.

Returning to FIG. 1, the motoring pressure calculating portion 144 calculates the estimated motoring pressure of the internal combustion engine 102 based on the sensor signal from the in-cylinder pressure sensor 104 during a predetermined crank angle period in a compression stroke. The calculation of the estimated motoring pressure is disclosed in detail in Japanese Patent Laid-Open No. 2006-274966, for example.

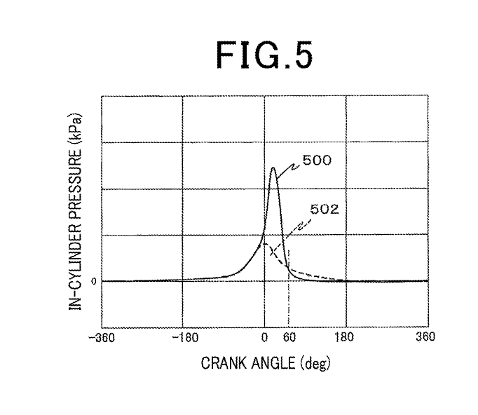

FIG. 5 is a graph showing an example of change curves of the estimated motoring pressure calculated by the motoring pressure calculating portion 144 and the in-cylinder pressure actually measured by the in-cylinder pressure sensor 104. In FIG. 5, the horizontal axis indicates the in-cylinder pressure, and the vertical axis indicates a crank angle with reference to a top dead center position. In the example shown in FIG. 5, in a range of the crank angle from about 60 degrees to about 180 degrees, a change curve 500 indicating the actual measured value of the in-cylinder pressure is below the estimated motoring pressure 502, and therefore the correction period determining portion 142 determines that the present time is in the correction period. In this case, the parameter correction portion 140 calculates the corrected operational parameter, using values of the estimated motoring pressure 502 in a range of the crank angle from about 60 degrees to about 180 degrees, and using values of the actual measured values of the in-cylinder pressure on the change curve 500 in a range of the crank angle other than the above-described range, for example.

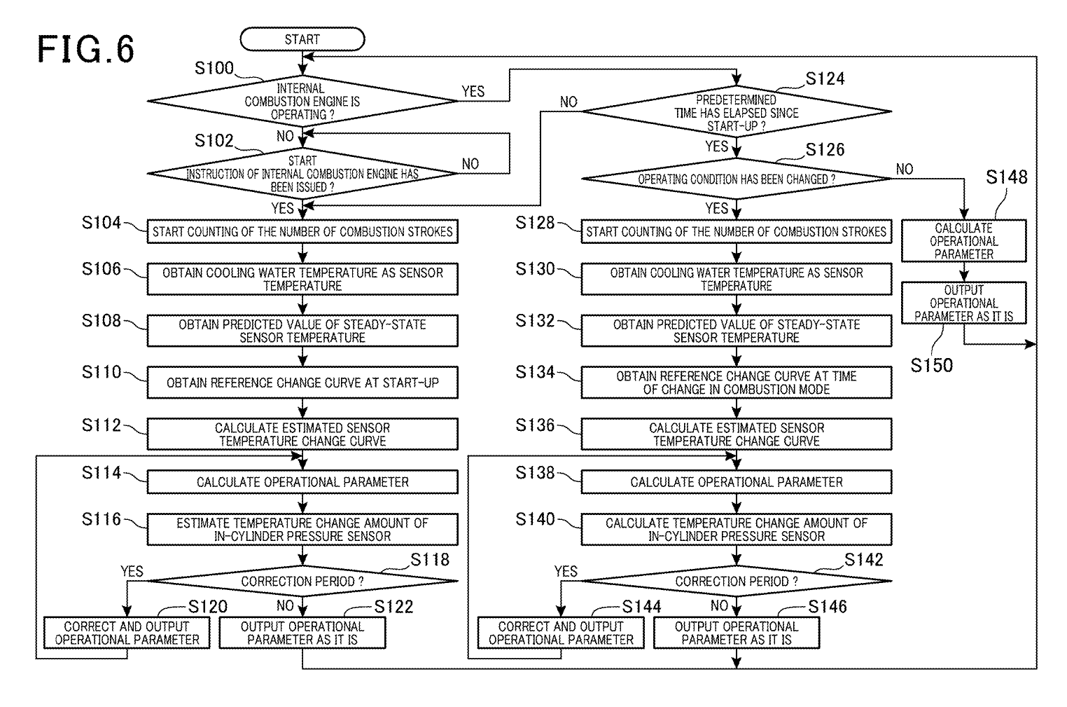

Next, the derivation processing of the operational parameter based on the sensor signal from the in-cylinder pressure sensor 104 in the electronic control unit 100 will be described with reference to a flowchart illustrated in FIG. 6. The processing is started when the power supply of the electronic control unit 100 is turned on, and is ended when the power supply of the electronic control unit 100 is turned off. Note that in parallel with the processing, the motoring pressure calculating portion 144 repeatedly calculates the estimated motoring pressure at a predetermined interval during operation of the internal combustion engine 102, based on the sensor signal from the in-cylinder pressure sensor 104.

When the electronic control unit 100 starts the operation, the sensor temperature estimating section 136 obtains the control information about the internal combustion engine 102 from e.g., the operation instruction section 130, to determine whether the internal combustion engine 102 is operating (S100). When the internal combustion engine 102 is not operating (S100, NO), the sensor temperature estimating section 136 determines whether a start instruction of the internal combustion engine 102 has been issued (S102). Here, the operation instruction section 130 may determine whether the start instruction of the internal combustion engine 102 has been issued, by determining whether it has been detected that the ignition switch (not illustrated) has been turned on, for example. In addition, in a case where the idle reduction system is enabled, the operation instruction section 130 may determine that the start instruction of the internal combustion engine 102 has been issued when predetermined conditions such as depressing of the accelerator pedal are satisfied, and may provide the control information indicating this determination result to the sensor temperature estimating section 136.

When in step S102, the start instruction of the internal combustion engine 102 has not been issued (S102, NO), the process returns to step S102, and the sensor temperature estimating section 136 waits until the start instruction is issued. On the other hand, when the start instruction has been issued (S102, YES), the sensor temperature estimating section 136 starts counting the number of combustion strokes (S104). The sensor temperature estimating section 136 may count the number of combustion strokes by obtaining the operation information on the spark plug 114 from the operation instruction section 130. The sensor temperature estimating section 136 also obtains the cooling water temperature measured by the water temperature sensor 106 as a current sensor temperature (that is, a sensor temperature at start instruction) (S106).

Next, the sensor temperature estimating section 136 obtains the operating condition of the internal combustion engine 102 through e.g., the operation instruction section 130, and obtains a predicted value of the steady-state sensor temperature in the above obtained operating condition from the steady-state sensor temperature map 152 stored in the storage device 122 based on the obtained operating condition (S108). The sensor temperature estimating section 136 obtains the reference change curve at start-up from the sensor temperature change curve map 154 stored in the storage device 122 (S110). The sensor temperature estimating section 136 calculates the estimated sensor temperature change curve (S112) by modifying the reference change curve at start-up obtained as described above so that the modified reference change curve at start-up connects the sensor temperature at start instruction obtained in step S106 with the predicted value of the steady-state sensor temperature obtained in step S108.

Subsequently, the operational parameter calculating section 132 measures the in-cylinder pressure based on the sensor signal from the in-cylinder pressure sensor 104, and calculates, for example, an IMEP which is an operational parameter, based on the measured value of the in-cylinder pressure (S114). Based on the count number of combustion strokes of the internal combustion engine 102 which is started counting in step S104 and the estimated sensor temperature change curve calculated in step S112, the sensor temperature estimating section 136 calculates the temperature change amount of the sensor temperature at the above count number of combustion strokes to estimate the current change amount of the sensor temperature (S116). The above calculated temperature change amount of the in-cylinder pressure sensor 104 is output to the parameter correction portion 140 from the sensor temperature estimating section 136.

Next, the correction period determining portion 142 of the operational parameter output section 134 determines whether the present time is in the correction period requiring the correction of the operational parameter calculated in step S114 (S118).

When the present time is in the correction period (S118, YES), on the basis of the temperature change amount of the in-cylinder pressure sensor 104 estimated in S116 by the sensor temperature estimating section 136,the parameter correction portion 140 refers to the correction amount map 150 stored in the storage device 122 to correct the operational parameter calculated by the operational parameter calculating section 132 in step S114, and outputs the corrected operational parameter. The operational parameter output section 134 provides the corrected operational parameter output by the parameter correction portion 140 to the operation instruction section 130 (S120). Then, the processing unit 120 returns the process to step S114, and repeats the aforementioned processing.

On the other hand, when in step S118, the correction period determining portion 142 determines that the present time is not in the correction period (S118, NO), the operational parameter output section 134 outputs the operational parameter calculated by the operational parameter calculating section 132 in step S114 as it is to the operation instruction section 130 (S122). Then, the processing unit 120 returns the process to step S100, and repeats the aforementioned processing.

On the other hand, when in step S100, the internal combustion engine 102 is operating (S100, YES), the operational parameter output section 134 determines whether a predetermined time (for example, two minutes) has elapsed since the start-up of the internal combustion engine 102 (S124). In this way, the operational parameter output section 134 determines whether the correction of the operational parameter in the warm-up period after the start-up of the internal combustion engine 102 has been completed.

When the predetermined time has not elapsed (S124, NO), the operational parameter output section 134 moves the process to step S104, and the correction process of the operational parameter after the start-up of the internal combustion engine 102 is repeated.

On the other hand, when the predetermined time has elapsed since the start-up of the internal combustion engine 102 (S124, YES), the sensor temperature estimating section 136 obtains the control information about the internal combustion engine 102 from e.g., the operation instruction section 130 to determine whether the operating condition of the internal combustion engine 102 has been changed (S126).

When the operating condition has been changed (S126, YES), the sensor temperature estimating section 136 starts counting the number of combustion strokes (S128), and obtains the cooling water temperature measured by the water temperature sensor 106 as a current sensor temperature (that is, a sensor temperature at changing the operating condition) (S130).

Next, the sensor temperature estimating section 136 obtains the operating condition after the operating condition is changed (the operating condition after change) through e.g., the operation instruction section 130 and obtains a predicted value of the steady-state sensor temperature in the above obtained operating condition after change from the steady-state sensor temperature map 152 stored in the storage device 122, based on the above obtained operating condition after change (S132). The sensor temperature estimating section 136 obtains the corresponding reference change curve at combustion-mode change from the sensor temperature change curve map 154 stored in the storage device 122 (S134). The sensor temperature estimating section 136 calculates the estimated sensor temperature change curve by modifying the reference change curve at combustion-mode change obtained above so that a sensor temperature at changing the operating condition obtained in step S130 is connected with the predicted value of the steady-state sensor temperature obtained in step S132 (S136) by the modified reference change curve at combustion-mode change.

Subsequently, the operational parameter calculating section 132 measures the in-cylinder pressure based on the sensor signal from the in-cylinder pressure sensor 104, and calculates, for example, an IMEP which is an operational parameter, based on the measured value of the in-cylinder pressure (S138). Based on the count number of combustion strokes of the internal combustion engine 102 which is started counting in step S128 and the estimated sensor temperature change curve calculated in step S136, the sensor temperature estimating section 136 calculates the temperature change amount of the sensor temperature at the above count number of combustion strokes to estimate the current change amount of the sensor temperature (S140). The above calculated temperature change amount of the in-cylinder pressure sensor 104 is output to the parameter correction portion 140 from the sensor temperature estimating section 136.

Next, the correction period determining portion 142 of the operational parameter output section 134 determines whether the present time is in the correction period requiring the correction of the operational parameter calculated in step S138 (S142).

When the present time is in the correction period (S142, YES), on the basis of the temperature change amount of the in-cylinder pressure sensor 104 estimated in S140 by the sensor temperature estimating section 136, the parameter correction portion 140 refers to the correction amount map 150 stored in the storage device 122 to correct the operational parameter calculated by the operational parameter calculating section 132 in step S138, and outputs the corrected operational parameter. The operational parameter output section 134 provides the corrected operational parameter output by the parameter correction portion 140 to the operation instruction section 130 (S144). Then, the processing unit 120 returns the process to step S138, and repeats the aforementioned processing.

On the other hand, when in step S142, the correction period determining portion 142 determines that the present time is not in the correction period (S142, NO), the operational parameter output section 134 outputs the operational parameter calculated by the operational parameter calculating section 132 in step S138 as it is to the operation instruction section 130 (S146). Then, the processing unit 120 returns the process to step S100, and repeats the aforementioned processing.

On the other hand, when the operating condition has not been changed (S126, NO), the operational parameter calculating section 132 calculates an IMEP which is an operational parameter, based on the sensor signal from the in-cylinder pressure sensor 104 (S148), and the operational parameter output section 134 outputs the calculated operational parameter as it is to the operation instruction section 130 (S150). Then, the processing unit 120 returns the process to step S100, and repeats the aforementioned processing.

As described above, the electronic control unit 100 illustrated in the present embodiment is a control device of an internal combustion engine which controls operation of the internal combustion engine 102 based on a sensor signal from the in-cylinder pressure sensor 104. The electronic control unit 100 includes the operational parameter calculating section 132 which calculates, based on the sensor signal from the in-cylinder pressure sensor 104, an operational parameter (for example, IMEP) related to control of the internal combustion engine 102, and the sensor temperature estimating section 136 which estimates the current temperature change amount of the in-cylinder pressure sensor 104 based on the operating state of the internal combustion engine 102. Also, the electronic control unit 100 includes the storage device 122 which stores the correction amount map 150 indicating a correction amount for the operational parameter in accordance with a temperature change amount of the in-cylinder pressure sensor 104. Furthermore, the electronic control unit 100 includes the operational parameter output section 134 which, based on the temperature change amount of the in-cylinder pressure sensor 104 estimated by the sensor temperature estimating section 136, refers to the correction amount map 150 to correct the above-described operational parameter calculated by the operational parameter calculating section 132, and outputs the corrected operational parameter.

According to this configuration, the control device can control operation of the internal combustion engine 102 with a smaller error by correcting precisely a detection result of an in-cylinder pressure sensor which may generate a detection error in a temperature changing process.

In the electronic control unit 100 of the present invention, the storage device 122 stores the steady-state sensor temperature map 152 indicating a steady-state sensor temperature which is a sensor temperature in a steady state under various operating conditions of the internal combustion engine 102. Furthermore, the storage device 122 stores the sensor temperature change curve map 154 which includes a predetermined reference change curve showing a change of the sensor temperature with respect to the number of combustion strokes of the internal combustion engine 102 from the time when the internal combustion engine 102 is started or the operating condition of the internal combustion engine 102 is changed to the time when the internal combustion engine 102 reaches the steady state. And, the sensor temperature estimating section 136 obtains the sensor temperature when the internal combustion engine 102 is started or when the operating condition of the internal combustion engine 102 is changed, and refers to the steady-state sensor temperature map 152 based on the operating condition after the internal combustion engine 102 is started or the operating condition after the operating condition is changed, to obtain an estimated value of the steady-state sensor temperature under the corresponding operating condition. The sensor temperature estimating section 136 estimates the current temperature change amount based on the sensor temperature obtained above, the estimated value of the steady-state sensor temperature, the reference change curve, and the number of combustion strokes from the time when the internal combustion engine 102 is started or the operating condition of the internal combustion engine 102 is changed to the present time.

According to this configuration, the control device can estimate the current temperature change amount of the in-cylinder pressure sensor 104 without requiring additional components such as a temperature sensor for directly measuring the temperature of the in-cylinder pressure sensor 104, and appropriately correct the operational parameter calculated based on the sensor signal of the in-cylinder pressure sensor 104, to thereby control the internal combustion engine 102 appropriately.

In the electronic control unit 100 of the present invention, the correction period determining portion 142 and the parameter correction portion 140 in the operational parameter output section 134 correct the above calculated operational parameter in the period during which the temperature change amount of the in-cylinder pressure sensor 104 estimated by the sensor temperature estimating section 136 is greater than or equal to a predetermined threshold. According to this configuration, the processing load for the operational parameter correction caused by a detection error of the in-cylinder pressure sensor 104 can be reduced in the processing unit 120.

In the electronic control unit 100 of the present invention, the above-described operational parameter includes at least one of an IMEP (Indicated Mean Effective Pressure), an estimated output torque, and a mass fraction burn curve. According to this configuration, various output characteristics of the internal combustion engine 102 can be controlled appropriately using various operational parameters.

In the electronic control unit 100 of the present invention, the operating conditions mean operating conditions which affect the combustion temperature in the cylinder. In the electronic control unit 100 of the present invention, more specifically, the above-described operational conditions include at least one of an air-fuel ratio, a compression ratio, an intake air amount, ignition timing, an EGR amount, air intake and exhaust timing, and a supercharging pressure. According to this configuration, the temperature change amount of the in-cylinder pressure sensor 104 can be estimated appropriately based on the operating conditions which affect the temperature change of the in-cylinder pressure sensor 104.

Note that the present invention is not limited to the configuration in the above-described embodiment, and can be implemented in various forms within the scope of the gist of the invention.

For example, in the above-described embodiment, the in-cylinder pressure sensor 104 is a ring-shaped in-cylinder pressure sensor, but is not limited thereto. The in-cylinder pressure sensor 104 can be an in-cylinder pressure sensor having any configuration in which an error may be generated in a sensor signal (i.e., in-cylinder pressure detection result) in the temperature changing process of the sensor housing.

In the above-described embodiment, in the correction amount map shown in FIG. 5 as one example of the correction amount map 150, the IMEP correction amount is defined for the sensor temperature change amount, but the present invention is not limited thereto. When the sensor temperature change amount may be uniquely defined according to the sensor temperature, in the correction amount map 150, the IMEP correction amount may be defined for the sensor temperature. In this case, the sensor temperature estimating section 136 can estimate the current sensor temperature based on the estimated sensor temperature change curve 200, and correct the operational parameters such as IMEP using the estimated sensor temperature and the correction amount map 150.

In the above-described embodiment, the operating condition of the internal combustion engine 102 is not changed frequently, the sensor temperature obtained before the operating condition of the internal combustion engine 102 is changed is in the steady state, and therefore the cooling water temperature measured by the water temperature sensor 106 is obtained as a current sensor temperature if the operating condition is changed, but the present invention is not limited thereto. In a case where the operating condition of the internal combustion engine 102 is changed, and the operating condition of the internal combustion engine 102 is further changed while the current sensor temperature is estimated based on the estimated sensor temperature change curve 300 or the like, the current estimated sensor temperature is obtained as a sensor temperature when the operating condition has been changed to perform the processes of steps S132 to S146 illustrated in FIG. 6, for example.

### REFERENCE SIGNS LIST

100 . . . Electronic control unit, 102 . . . Internal combustion engine, 104 . . . In-cylinder pressure sensor, 106 . . . Water temperature sensor, 108 . . . Air flow sensor, 110 . . . Crank angle sensor, 112 . . . Fuel injection valve, 114 . . . Spark plug, 116 . . . Intake valve, 118 . . . Accelerator pedal position sensor, 120 . . . Processing unit, 122 . . . Storage device, 130 . . . Operation instruction section, 132 . . . Operational parameter calculating section, 134 . . . Operational parameter output section, 136 . . . Sensor temperature estimating section, 140 . . . Parameter correction portion, 142 . . . Correction period determining portion, 144 . . . Motoring pressure calculating portion, 150 . . . Correction amount map, 152 . . . Steady-state sensor temperature map, 154 . . . Sensor temperature change curve map

What is claimed is:

1. A control device for an internal combustion engine which controls operation of the internal combustion engine based on a sensor signal from an in-cylinder pressure sensor, the control device comprising:
an operational parameter calculating section that calculates an operational parameter related to control of the internal combustion engine based on the sensor signal from the in-cylinder pressure sensor;
a sensor temperature estimating section that estimates a current temperature change amount of a sensor temperature which is a temperature of the in-cylinder pressure sensor based on an operating state of the internal combustion engine;
a storage section which stores a correction amount map indicating a correction amount for the operational parameter in accordance with a temperature change amount of the in-cylinder pressure sensor; and
an operational parameter output section that corrects the operational parameter calculated by the operational parameter calculating section with reference to the correction amount map based on a temperature change amount of the in-cylinder pressure sensor estimated by the sensor temperature estimating section, to output the corrected operational parameter.

2. The control device for an internal combustion engine according to claim 1, wherein
the storage section further stores a steady-state sensor temperature map that indicates a steady-state sensor temperature which is a sensor temperature in a steady state under various operating conditions of the internal combustion engine, and a sensor temperature change curve map that includes a predetermined reference change curve showing a change of the sensor temperature with respect to the number of combustion strokes of the internal combustion engine from a time when the internal combustion engine is started or an operating condition of the internal combustion engine is changed to a time when the sensor temperature reaches the steady-state sensor temperature, and
the sensor temperature estimating section
obtains the sensor temperature when the internal combustion engine is started or when the operating condition of the internal combustion engine is changed,
refers to the steady-state sensor temperature map based on the operating condition after the internal combustion engine is started or after the operating condition is changed, to obtain an estimated value of the steady-state sensor temperature under the corresponding operating condition,
estimates a current change amount of the sensor temperature based on the sensor temperature, the estimated value of the steady-state sensor temperature, the reference change curve, and the number of combustion strokes from the time when the internal combustion engine is started or the operating condition is changed to a present time, which are obtained above, and
uses the estimated current change amount of the sensor temperature as the temperature change amount of the in-cylinder pressure sensor.

3. The control device for an internal combustion engine according to claim 2, wherein
the operational parameter output section corrects the calculated operational parameter in a period during which a temperature change amount of the in-cylinder pressure sensor estimated by the sensor temperature estimating section is greater than or equal to a predetermined threshold.

4. The control device for an internal combustion engine according to claim 1, wherein
the operational parameter includes at least one of an indicated mean effective pressure, an estimated output torque, and a mass fraction burn curve.

5. The control device for an internal combustion engine according to claim 2, wherein
the operational parameter includes at least one of an indicated mean effective pressure, an estimated output torque, and a mass fraction burn curve.

6. The control device for an internal combustion engine according to claim 3, wherein
the operational parameter includes at least one of an indicated mean effective pressure, an estimated output torque, and a mass fraction burn curve.

7. The control device for an internal combustion engine according to claim 2, wherein
the operating condition is an operating condition which affects a combustion temperature in a cylinder.

8. The control device for an internal combustion engine according to claim 3, wherein
the operating condition is an operating condition which affects a combustion temperature in a cylinder.

9. The control device for an internal combustion engine according to claim 7, wherein
the operating condition includes at least one of an air-fuel ratio, a compression ratio, an intake air amount, ignition timing, an EGR amount, air intake and exhaust timing, and a supercharging pressure.

10. The control device for an internal combustion engine according to claim 8, wherein
the operating condition includes at least one of an air-fuel ratio, a compression ratio, an intake air amount, ignition timing, an EGR amount, air intake and exhaust timing, and a supercharging pressure.
